(19) United States
(12) Patent Application Publication
(10) Pub. No.: US 2023/0166949 A1
(43) Pub. Date: Jun. 1, 2023

(54) WINCH WITH SPOOL AND REMOTE TENSIONING WHEEL

(71) Applicant: Hall Labs LLC, (US)

(72) Inventors: David R. Hall, Provo, UT (US); Jerome Miles, Spanish Fork, UT (US)

(73) Assignee: Hall Labs LLC, Provo, UT (US)

(21) Appl. No.: 18/060,536

(22) Filed: Nov. 30, 2022

Related U.S. Application Data
(60) Provisional application No. 63/284,370, filed on Nov. 30, 2021.
(60) Provisional application No. 63/373,327, filed on Aug. 23, 2022.
(60) Provisional application No. 63/373,324, filed on Aug. 23, 2022.

(51) Int. Cl. B66D 1/02; B66D 1/28

(52) U.S. Cl. CPC B66D 1/02; B66D 1/28; B66D 2700/0125

(57) ABSTRACT

A winch is disclosed having a motor, a spool rotated by the motor, and a line carried by the spool. Rotating the spool in a first, or winding direction causes the line to wind around the spool, and rotating the spool in a second, or unwinding direction causes the line to unwind from the spool. The winch also includes a tensioning device spaced apart from the spool, which tensioning device comprises a tensioning wheel that engages the line and is configured to apply tension to the line as it is being unwound.

### CROSS-REFERENCE TO RELATED PATENT APPLICATIONS

This application claims priority to U.S. Provisional Patent Application No. 63/284,370 entitled “Winch with Spool and Remote Tensioning Wheel,” filed on Nov. 30, 2021. This application also claims priority to U.S. Provisional Patent Application No. 63/373,327, entitled “Winch with Supporting Tie Rod,” filed on Aug. 23, 2022. This application also claims priority to U.S. Provisional Patent Application No. 63/373,324, entitled “Raisable Grow System,” filed on Aug. 23, 2022. The entire disclosures of these three prior applications are incorporated herein by reference.

### TECHNICAL FIELD

The present disclosure is directed to the field of lifters, hoists, and winches.

### BACKGROUND

Lifters, hoists, and winches are used extensively to lift, lower, or pull loads of various kinds. Such devices typically include a line, such as a cable or chain, wrapped around a spool. To lift, lower, or pull a load, the spool may be manually rotated or driven with a motor, such as an electrical, hydraulic, or pneumatic motor. When rotation is not desired, a braking mechanism may be used to prevent the spool from turning. This may maintain tension in the line, keep a load suspended, or prevent the release or unspooling of the line. To keep the line from bunching on the spool, some hoists or winches may include guides or other mechanisms to evenly wind the line around the spool.

Although a wide variety of lifters, hoists and winches are available, many have shortcomings that prevent or discourage their use in various applications. For example, some hoists or winches are bulky or cumbersome, which may prevent their use in applications where greater compactness is required or desired. Other hoists and winches may be economically infeasible for use in applications such as consumer or residential applications due to their complexity or expense.

Maintaining a flexible line in an orderly way and preventing excessive slack, bunching, and misalignment ensures proper winch operation. Without proper spacing, tension, and alignment the flexible line can become jammed or wear unevenly leading to material degradation or even failure. There is a need in the art for a winch that can maintain a flexible line in an efficient way to ensure a long effective life of the device.

### SUMMARY

Embodiments of the present disclosure are directed to a winch including a motor, a spool rotated by the motor, and a line carried by the spool wherein rotating the spool in a first direction causes the line to wind around the spool. Rotating the spool in a second direction causes the line to unwind from the spool. The winch also includes a tensioning device spaced apart from the spool, which tensioning device comprises a tensioning wheel that engages the line and is configured to apply tension to the line as it is being unwound.

Further embodiments of the present disclosure are directed to a winch including a motor, a spool with a line attached to the spool, the spool being rotated by the motor to wind and unwind the line from the spool, and a tensioning device coupled to the motor. Rotation of the motor causes rotation of the spool and tensioning device together, the tensioning device contacting the line a distance apart from the spool, the tensioning device having a driven wheel that is powered by the motor and a passive wheel opposite the driven wheel. The passive wheel rotates freely. The driven wheel rotates at least 1% faster than the line unwinds from the spool such that the driven wheel exerts a tension on the line.

Other embodiments of the present disclosure are directed to a winch including a line wound around a spool and a motor coupled to the spool and configured to rotate the spool to wind and unwind the line around the spool. The winch also includes a tensioning device spaced apart from the spool and being configured to receive the line between a driven wheel and a passive wheel, the driven wheel being coupled to the motor and configured to rotate at least 1% faster than the line to create a tension on the line.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a side view of a multiple spool driveshaft assembly for a winch according to embodiments of the present disclosure.

FIG. 2 is an enlarged view of a spool assembly according to embodiments of the present disclosure.

FIG. 3 is an end view of the driveshaft assembly according to embodiments of the present disclosure.

FIG. 4 is a schematic illustration of a winch with a remote tensioning wheel assembly according to embodiments of the present disclosure.

FIG. 5 is a schematic illustration of the winch with a remote tensioning wheel assembly according to embodiments of the present disclosure.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “winch” refers to lifting or pulling device consisting of a line winding around a horizontal rotating drum, turned by a crank or by motor or other power source.

As used herein, “winch,” “hoist,” “lift,” “winching device,” “hoisting device,” and “lifting device” are meant to refer to an apparatus that can be actuated to selectively raise and lower an object. These terms are generally interchangeable except for where specifically noted herein.

“Spool” is meant to refer to a generally cylindrical member that rotates to wind a line thereon.

“Line” is meant to refer to a cable, cord, wire, or other suitable interchangable generally elongated, flexible, member that winds onto the spool.

FIG. 1 is a side view of a multiple spool driveshaft assembly 200 for a winch according to embodiments of the present disclosure. The driveshaft assembly 200 can be used in a similar way to other winches that are used in garages or other such places to lift objects up and down as needed. The winches include a flexible line that winds onto and off of a spool to retract and extend the line from the winch. The line can be attached to any object to be lifted.

The driveshaft assembly 200 includes a driveshaft 202 that is an elongated cylindrical member. The length of the driveshaft 202 can vary as needed according to various installations. The assembly also includes a first end plate 204 and a second end plate 206 opposite the first end plate 204. A motor 205 can be located within the driveshaft 202 or can be externally mounted and provides the power to rotate the driveshaft 202. The driveshaft 202 can include a key 207 that can be used to mount the driveshaft 202 to the motor 205 in the case of an external mount. The assembly 200 also includes a first rail 208 and a second rail 210 rotatably connected to the end plates 204, 206, respectively. In some embodiments there may be a single rail.

The driveshaft assembly 200 also includes four spool assemblies: first spool assembly 220, second spool assembly 222, third spool assembly 224, and fourth spool assembly 226. There may be any suitable number of spool assemblies as desired for a given installation. In some embodiments each individual spool assembly is identical; however, in some embodiments each spool assembly can carry a different type of line, such as a load-bearing line, a power/data cable, or even a fluid conduit such as an air tube or a water tube. As used here, the term “fluid” can refer to a vacuum.

The spool assemblies are fitted to the driveshaft 202 and can be selectively moved along the length of the driveshaft 202. In some embodiments the spool assemblies are friction fit onto the spool assemblies such that they are movable by grasping and sliding them along the driveshaft 202 but are otherwise maintain their position. In some embodiments there is a fastener such as a lever or set screw or any other suitable fastener that enables selective placement of the spool assemblies along the driveshaft 202. In some embodiments the driveshaft 202 is smooth, allowing for continuous placement of the spool assemblies at any desired position. In other embodiments the driveshaft 202 can have notches that receive a detent on the interior of the spool assemblies at desired spacings. In still other embodiments the driveshaft 202 may have a hexagonal shape to allow axial sliding of the spools but ensuring that the spools rotate with the driveshaft 202. Other faceted shapes are also possible and is not limited to a hexagonal shape.

In the depicted embodiment the first spool assembly 220 and fourth spool assembly 226 are attached to the second rail 210, and the second spool assembly 222 and third spool assembly 224 and fourth spool assembly 226 are attached to the first rail 208. It is to be appreciated that this arrangement can vary as desired. There may be one, two, three, or more rails as needed, and any number of the spool assemblies can be attached to any of the rails.

The ability to move the spool assemblies along the driveshaft 202 enables the lines to be positioned at different points along the driveshaft 202 which can then be attached to an object to be lifted. By contrast, using two independent winches requires synchronization between the winches to achieve uniform raising and lowering of two or more lines. The driveshaft assembly 200 eliminates all synchronization issues because a single motor turns the spools at the same rate.

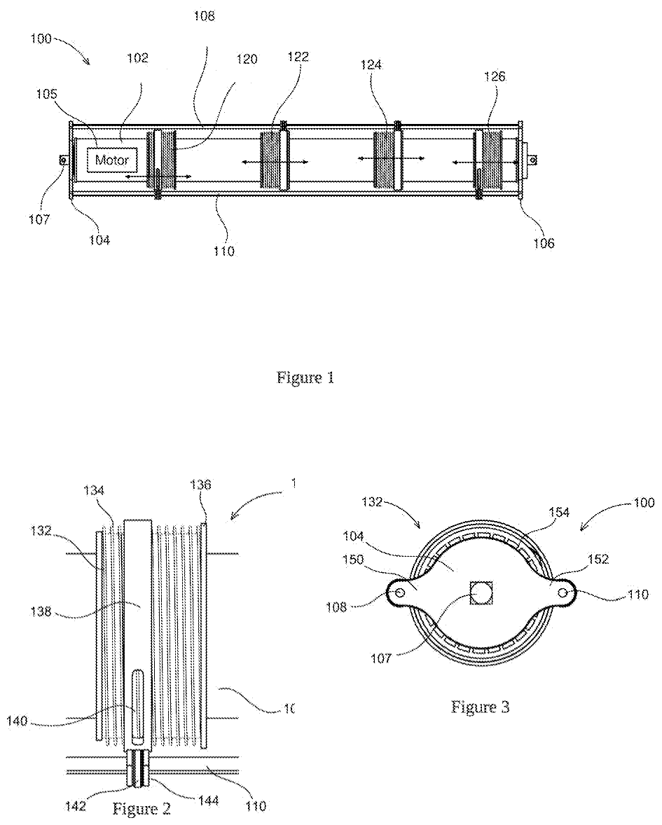

FIG. 2 is an enlarged view of a spool assembly 230 according to embodiments of the present disclosure. The spool assembly 230 includes a spool 232 having a helical groove 234 formed in an external surface of the spool 232. The helical groove 234 carries a line (not shown) wound around the spool 232. The spool 232 includes a flange 236 at one end of the spool 232 to provide an attachment point for the line. The spool assembly 230 also includes a line guide 238 that encircles the spool 232 and allows the line to wind onto the spool. The line guide 238 has a slot 240 through which the line passes.

The spool assembly 230 also includes a tensioning wheel 242 and a wheel support 244 to align the line as it winds onto and off of the spool 232. The wheel support 244 is mounted to the rail 210 with the tensioning wheel 242 being rotated by rotation of the rail 210, while the wheel support 244 allows the rail 210 to rotate within it. In some embodiments the wheel support 244 comprises a one-way bearing that can transfer torque in one direction and allows free movement in the other direction. The rotation of the rail 210 causes the one-way bearing to rotate the tensioning wheel 242 as the spool 232 rotates to pay out the line and to provide a slight tension to the line to ensure the line does not slack as it unwinds. When the spool 232 is rotated to wind the line, the one-way bearing does not transmit torque from the rail and the tensioning wheel 242 therefore does not inhibit the line winding around the spool 232. The rail 210 can rotate at a rate that causes the tensioning wheel 242 to slip slightly as the line is wound to the spool 232. The friction and slipping ensures that the line winds properly. In other words, the wheel speed is slightly faster than the line speed. The line guide 238, wheel support 244, and tensioning wheel 242 all move axially relative to the spool 232 as the spool 232 rotates. In some embodiments the line guide 238 is moved axially by the line, and in other embodiments the line guide 238 is keyed to the spool 232 such that the helical groove 234 causes the axial movement.

The tensioning wheel 242 of the present disclosure contacts an exposed surface of the line as it winds onto the spool 232 and moves at a speed based on the rotational speed of the spool 232. The radius is measured from the center of rotation of the spool 232, to the exposed surface of the line. This speed is referred to herein as the “line speed.” The line speed may also be referred to as the tangential speed. The tensioning wheel 242 has a contact surface that contacts the line. The tensioning wheel 242 rotates at a certain rotational rate which can be manipulated as needed. The speed of the contact surface of the tensioning wheel 242 is referred to herein as the “tensioning wheel speed.”

The gears of the winch and the tensioning wheel itself are constructed such that the tensioning wheel speed is between 1% and 50% faster than the line speed. The dimensions of the spool 232, line, and tensioning wheel 242 may vary. Accordingly, the tensioning wheel 242 frictionally slips along the line slightly to ensure there is tension on the line as it pays out. That is, the wheel drags along the line using the friction between the two to create the tension. If the speeds were identical there would be no frictional slip and the movement would be one-to-one. With a speed differential the wheel “slips” or “drags” along the line, thereby creating the desired tension. As the line is wound onto the spool 232, the one-way bearing allows the tensioning wheel 242 to spin freely, whether or not it contacts the line.

FIG. 3 is an end view of the driveshaft assembly 200 according to embodiments of the present disclosure. The key 207 for mating to an externally mounted motor is visible having a squared profile. A hexagonal or other torque-transmitting profile can also be found in some embodiments. The end plate 204 is shown and includes a first tab 250 for accommodating the first rail 208, and a second tab 252 for accommodating the second rail 210. The rails can rotate with respect to the tabs. In other embodiments there may be a single rail and accordingly the end plate 204 will have a single tab 250. In still other embodiments there may be three or more tabs accommodating three or more rails. The spool 232 is visible and includes spokes 254 that support the spool 232 and may provide sufficient flexibility to the spool 232 to allow selective movement along the driveshaft while grasping the driveshaft sufficiently firmly that rotation of the motor rotates the spool 232.

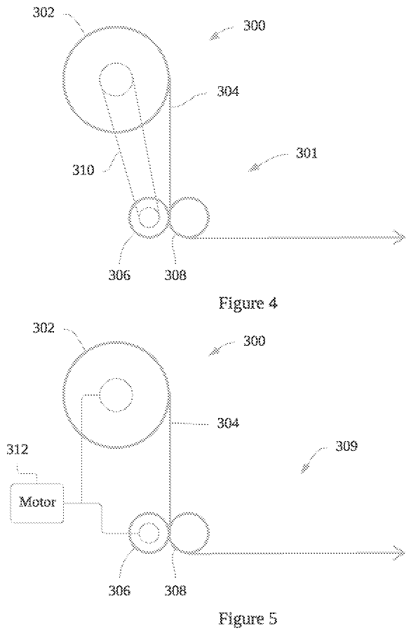

FIG. 4 is a schematic illustration of a winch 300 with a remote tensioning wheel assembly 301 according to embodiments of the present disclosure. The winch 300 includes a spool 302 carrying a line 304. The spool 302 can be mounted to a driveshaft (not pictured) and can be similar to other spools on other winch embodiments throughout this disclosure. The winch 300 includes a remote tensioning wheel assembly 301 that includes a driven wheel 306 and a passive wheel 308. The line 304 extends from the spool 302 between the driven wheel 306 and passive wheel 308 and from there the line 304 can continue onward to its final destination which may include a hook, clip, or other physical attachment means. In some embodiments the line 304 is a non-load bearing line such as an electronic line or a fluid line. The driven wheel 306 is coupled to rotation of the spool via a belt 310. The belt 310 rotates the driven wheel 306 when so directed. The driven wheel 306 can include a one-way bearing that allows the motor and belt 310 to drive the driven wheel 306 to pay out the line 304 from the winch 300. When spooling the line 304 back onto the spool 302 the one-way bearing permits free rotation to guide the line 304 but not create any tension in the line 304. In some embodiments the ratio of the belt 310 to the driven wheel 306 is chosen such that the driven wheel 306 frictionally slips along the line 304 as the line is paying out from the spool 304. In other embodiments the speed is matched and the driven wheel 306 does not slip along the line 304 more than a negligible amount. The function of the belt 310 can also be achieved in some embodiments by a chain, a gear, or any other suitable mechanical equivalent.

FIG. 5 is a schematic illustration of the winch 300 with a remote tensioning wheel assembly 309 according to embodiments of the present disclosure. The winch 300 includes the spool 302, line 304, driven wheel 306, and passive wheel 308 and also includes a motor 312 that is coupled to the spool 302 and to the driven wheel 306 independently from one another. In some embodiments the passive wheel is not passive, and is instead a second driven wheel. It is to be appreciated that the mechanical transmission of power from the motor 312 to the spool 302 and to the driven wheel 306 is depicted in a schematic way. In some embodiments the motor 312 is a second motor different from the motor shown in FIG. 1. The first motor and second motors 312 can be operated in sync to ensure their timings are appropriate. In some embodiments the second motor 312 moves between 1% and 25% faster than the first motor to move the driven wheel faster than the line such that the driven wheel can exert a tension on the line. Any suitable mechanical means for transmitting power can be used, including a belt, a chain, a series of gears, etc. Also the motor may be an electrical motor or any equivalent power source. The motor 312 is coupled to the driven wheel 306 separately from how the motor 312 is coupled to the spool 302 and the coupling may be operated differently. In other embodiments there are two motors. For example, if it is desired to run the driven wheel 306 at a different ratio to the spool the separate coupling allows it. In some embodiments the coupling between the motor 312 and the driven wheel 306 includes a selectively activatable clutch that allows the remote tensioning wheel assembly 309 to be selectively run forwards, backwards, or allowed to spin freely. In some embodiments the driven wheel 306 can be used to tension the line 304 in both directions, and sometimes it is desired to allow free rotation. In other embodiments the motor 312 can be coupled to both the driven wheel 306 and the passive wheel 308 in which case the passive wheel 308 can be a second driven wheel. In some embodiments the motor 312 can comprise a first motor for driving the spool 302 and a second motor for driving the driven wheel 306.

The depicted remote tensioning wheel assemblies shown in FIGS. 3 and 4 have the driven wheel 306 and passive wheel 308 spaced apart from the spool 302. The distance away from the spool 302 may vary. This arrangement allows the spool 302 to be located in a different location than the tensioning wheels. In some embodiments there may be more than one tensioning wheel pair on the line 304. Any one or more of the tensioning wheels in the series can be driven by the motor 312, either through a direct coupling between the driven wheel 306 and the spool 302, or through an independent coupling.

It is noted that, although much of the discussion above has involved lifting objects with the winches described, the disclosed winches can also be used for pulling objects. The tensioning wheel, that assures that the line is pulled off the spool as it is being unwound, is particularly advantageous to these pulling embodiments, that do not have gravity to assist pulling the line off the spool.

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A winch comprising:
a motor;
a spool rotated by the motor;
a line carried by the spool wherein rotating the spool in a winding direction causes the line to wind around the spool, and rotating the spool in an unwinding direction causes the line to unwind from the spool; and
a tensioning device spaced apart from the spool, which tensioning device comprises a tensioning wheel that engages the line and is configured to apply tension to the line as it is being unwound.

2. The winch of claim 1 wherein the tensioning wheel is driven by the motor, and wherein the tensioning device further comprises a passive wheel opposite the tensioning wheel with the line passing between the tensioning wheel and the passive wheel.

3. The winch of claim 1, further comprising a one-way bearing on the tensioning device and configured to allow free rotation of the tensioning device when rotating the spool in the winding direction and to rotate at least the tensioning wheel to apply tension to the line when rotating the spool in the unwinding direction.

4. The winch of claim 1 wherein the line unwinds from the spool at a line speed and the tensioning wheel has a contact point configured to contact the line, the contact point having a tangential speed when the tensioning wheel rotates, and wherein the wheel speed is at least 5% faster than the line speed.

5. The winch of claim 4 wherein the tangential speed is no greater than 25% faster than the line speed.

6. The winch of claim 1 wherein the tensioning wheel frictionally slips along the line as the tensioning wheel creates tension in the line.

7. The winch of claim 2, further comprising a first pulley coupled to the motor, a coupler rotated by the first pulley and a second pulley coupled to the tensioning wheel and rotated by the coupler.

8. The winch of claim 7, wherein the coupler is a belt.

9. The winch of claim 8, wherein the coupler is a toothed belt configured to mesh with the first and second pulleys.

10. The winch of claim 7, wherein the size of the first pulley and the second pulley are selected so that the tensioning wheel has a tangential speed at least 5% faster than the line speed when the line is being unwound.

11. The winch of claim 8, further comprising a one-way bearing between the second pulley and the tensioning wheel, whereby the tensioning wheel is rotated by the line as it is being wound.

12. The winch of claim 1 wherein the tensioning wheel is driven by a second motor, wherein the tensioning device further comprises a passive wheel opposite the tensioning wheel with the line passing between the tensioning wheel and the passive wheel, and wherein the second motor is synchronized with the motor, so that the tensioning wheel has a tangential speed at least 5% faster than the line speed when the line is unwound.

13. The winch of claim 12, wherein the second motor is synchronized with the motor so as to have a tangential speed at least 5% slower than the line speed when the line is wound.

14. The winch of claim 12, wherein the tensioning device comprises a one-way bearing between the second motor and the tensioning wheel, whereby the tensioning wheel is driven by the second motor when the line is unwound, and whereby the tensioning wheel is not driven by the second motor when the line is wound.

15. The winch of claim 1, further comprising a driveshaft rotated by the motor, wherein the spool is mounted to the driveshaft such that the spool rotates with the driveshaft.

16. The winch of claim 15, further comprising:
a second spool mounted axially spaced apart from the spool;
a second line carried by the second spool;
a second tensioning device spaced apart from the second spool, which second tensioning device comprises a tensioning wheel that engages the line and is configured to apply tension to the line as it is being unwound.

17. The winch of claim 1, further comprising a driveshaft having a non-circular cross-sectional shape, wherein the spool has a corresponding non-circular interior shape and is mounted to the driveshaft such that the non-circular shape of the driveshaft substantially matches the non-circular shape of the spool, and thereby the spool and driveshaft rotate together.

18. The winch of claim 16 wherein the second line is configured to deliver at least one utility selected from electric power, data, and fluid.

19. A winch, comprising:
a motor;
a spool with a line attached to the spool, the spool being rotated by the motor to wind and unwind the line from the spool;
a tensioning device coupled to the motor, wherein rotation of the motor causes rotation of the spool and tensioning device together, the tensioning device contacting the line a distance apart from the spool, the tensioning device having a driven wheel that is powered by the motor and a passive wheel opposite the driven wheel, the passive wheel rotating freely, wherein the driven wheel rotates at least 1% faster than the line unwinds from the spool such that the driven wheel exerts a tension on the line.

20. A winch, comprising:
a line wound around a spool;
a motor coupled to the spool and configured to rotate the spool to wind and unwind the line around the spool;
a tensioning device spaced apart from the spool and being configured to receive the line between a driven wheel and a passive wheel, the driven wheel being coupled to the motor and configured to rotate at least 1% faster than the line to create a tension on the line.
